(19) United States
(12) Patent Application Publication
(10) Pub. No.: US 2026/0060447 A1
(43) Pub. Date: Mar. 5, 2026

(54) TELESCOPIC MECHANISM AND BABY BED

(71) Applicant: WONDERLAND SWITZERLAND AG, Steinhausen (CH)

(72) Inventor: Junjie HU, Dongguan, Guangdong (CN)

(73) Assignee: WONDERLAND SWITZERLAND AG, Steinhausen (CH)

(21) Appl. No.: 19/106,930

(22) PCT Filed: Aug. 14, 2023
(86) PCT No.: PCT/EP2023/072373

§ 371 Date: Feb. 26, 2025

(30) Foreign Application Priority Data
Aug. 26, 2022 (CN) 202222280442.9

(51) Int. Cl. A47D 9/00; F16B 7/10

(52) U.S. Cl. CPC A47D 9/012; F16B 7/105

(57) ABSTRACT

The present application discloses a telescopic mechanism, comprising: a first housing; a second housing sleeved in the first housing and movable between an extended position and a retracted position relative to the first housing; an engagement member at least partially arranged in the second housing, and engageable the second housing in the extended position. The present application also discloses a baby bed.

### TECHNICAL FIELD

The present application relates to a telescopic mechanism, in particular to a telescopic mechanism with an engagement device, and also relates to a baby bed comprising the telescopic mechanism.

### BACKGROUND

A baby bed is a commonly used children's item, and the baby bed placed next to an adult bed is called a bedside bed. The bedside bed provides great convenience for the care of infants. Caregivers usually purchase a bedside bed that is equivalent in height to an adult bed. During the sleep time at night, the bedside bed is placed near to an adult bed for easy care. However, to ensure the stability of the bedside bed when used alone, the feet of the bedside bed are usually set to extend out of the bed body. In general, the feet of the bedside bed can extend into the bottom of the adult bed, making the bedside bed close to the adult bed for easy care of children. However, when the bedside bed is used close to the adult bed with no gap between the bottom and the ground, the feet will interfere with the adult bed, resulting in a gap between the bedside bed and the adult bed, which is not convenient for taking care of children in the bedside bed.

### SUMMARY

A telescopic mechanism according to the present application, comprising: a first housing; a second housing sleeved in the first housing and movable between an extended position and a retracted position relative to the first housing; and an engagement member at least partially arranged in the second housing and engageable with the second housing in the extended position.

In one embodiment, the engagement member comprises a first protrusion matched into an engagement hole of the first housing when the second housing is in the extended position.

In one embodiment, the telescopic mechanism further comprises an operating member operated to act on the engagement member, causing the first protrusion to detach from the engagement hole, wherein the operating member is releasable to allow the first protrusion to bounce back into the engagement hole.

In one embodiment, the engagement member includes an engagement part engageable to the first housing, wherein the first protrusion is arranged at a free end of the engagement part.

In one embodiment, the operating member is provided on the first housing and can be pressed; the engagement part is provided as an elastic sheet that bounces towards an outside of the first housing, and when the second housing is in the extended position, the engagement part is pressed by the operating member to disengage with the first housing.

In one embodiment, the engagement member comprises a limiting part extending from the second housing to the first housing and engaged in the first housing to limit a movement range of the second housing.

In one embodiment, the limiting part extends towards the interior of the first housing, and a limiting groove is provided in the limiting part; and a guiding pin is provided in the first housing, and is inserted into the limiting groove to guide a movement of the second housing.

In one embodiment, the engagement member includes at least one sleeve, which extends from an end of the second housing inserted into the first housing towards an outside of the first housing; and at least one column is provided in the first housing, and is insertable into the sleeve to guide a movement of the second housing.

In one embodiment, an intermediate part arranged at an end of the second housing inserted into the first housing; wherein the engagement part extends from the intermediate part towards the outside of the first housing.

In one embodiment, the sleeves include a first sleeve and a second sleeve, respectively extending from the intermediate part towards the outside of the first housing; and the columns include a first column and a second column, and when the second housing is in the retracted position, the first column and the second column are at least partially inserted into the first sleeve and the second sleeve, respectively.

In one embodiment, a length of the first column is greater than a length of the second column, and when the second housing is in the extended position, at least a part of the first column is located within the first sleeve.

In one embodiment, the telescopic mechanism is further provided with an elastic element, wherein the elastic element is sleeved on the second column and inserted into the second sleeve to bias the second housing towards the extended position.

In one embodiment, the engagement member is further provided with a second protrusion which is arranged to be inserted into an opening of a wall of the second housing to connect the engagement member to the second housing.

A baby bed according to the present application comprising: a bed body; a supporting foot is arranged below the bed body; and the telescopic mechanism according to the present application, wherein the first housing is connected to a lower end of the supporting foot, and two second housings are respectively sleeved at longitudinal ends of the first housing.

### BRIEF DESCRIPTION OF THE DRAWINGS

FIG. 1 is a three-dimensional view of the baby bed according to the present application;

FIG. 2 is a three-dimensional view of the supporting foot and telescopic mechanism, with the second housing in the extended position;

FIG. 3 is a three-dimensional view of the supporting foot and telescopic mechanism, with one second housing in the retracted position and the other second housing in the extended position;

FIG. 4 is a three-dimensional view of the engagement member;

FIG. 5A is a cross-sectional view taken along the A-A line in FIG. 1, with the second housing in the extended position, and FIG. 5B is a partial enlarged view of the box part of FIG. 5A;

FIG. 6A is a cross-sectional view taken along the A-A line in FIG. 1, with one second housing in the retracted position and the other second housing in the extended position, and

FIG. 6B is a partial enlarged view of the box part of FIG. 6A;

FIG. 7 is a cross-sectional view taken along the B-B line in FIG. 1, with the second housing in the extended position;

FIG. 8 is a cross-sectional view taken along the B-B line in FIG. 1, with one of the second housings in the retracted position.

### LIST OF REFERENCE MARKS

100 Baby Bed
110 First Housing
111 First Column
112 Second Column
113 Guiding Pin
114 Engagement hole
115 Plug
120 Second Housing
121 Opening
130 Engagement Member
131 Limiting Part
132 Limiting Groove
133 First Sleeve 133a Air Hole
134 Second Sleeve
135 Engagement Part
136 First Protrusion
137 Second Protrusion
138 Intermediate Part
140 Operating Member
141 Fixed End
142 Operating End
150 Elastic Member
160 Supporting Foot

### DETAILED DESCRIPTION

Although this description refers to specific embodiments to illustrate and describe the present utility model, it should not be limited to the details shown. Specifically, within the scope of the equivalent solutions of the claims and without departing from the present utility model, various modifications can be made to these details.

The descriptions of “front”, “back”, “up”, “down” and other directions mentioned herein are only for the convenience of understanding. The present utility model is not limited to these directions, but can be adjusted according to actual situations. Although the present application has been described in typical embodiments, the terms used are illustrative and exemplary, rather than restrictive.

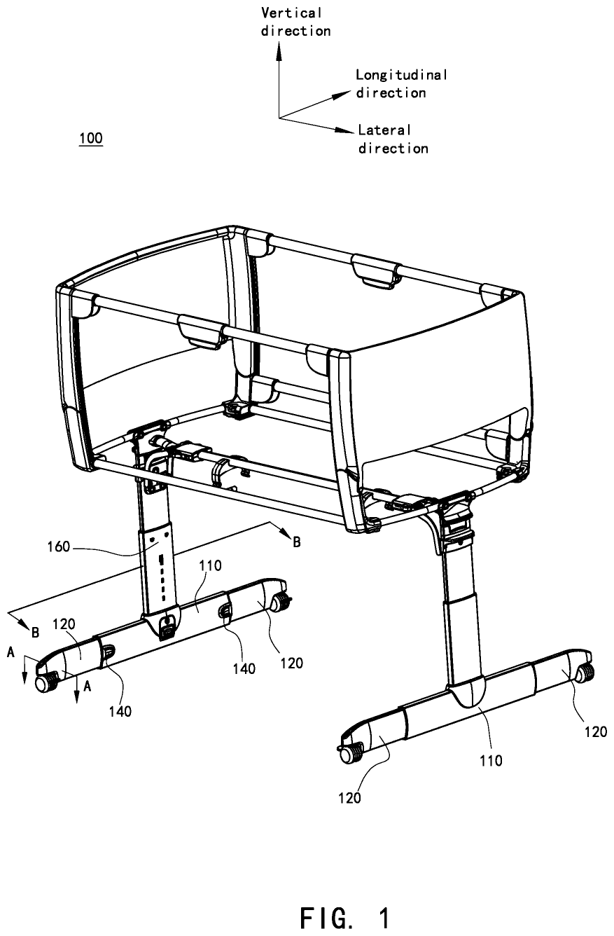

Referring to FIGS. 1 to 3, the baby bed 100 according to the present application will generally described.

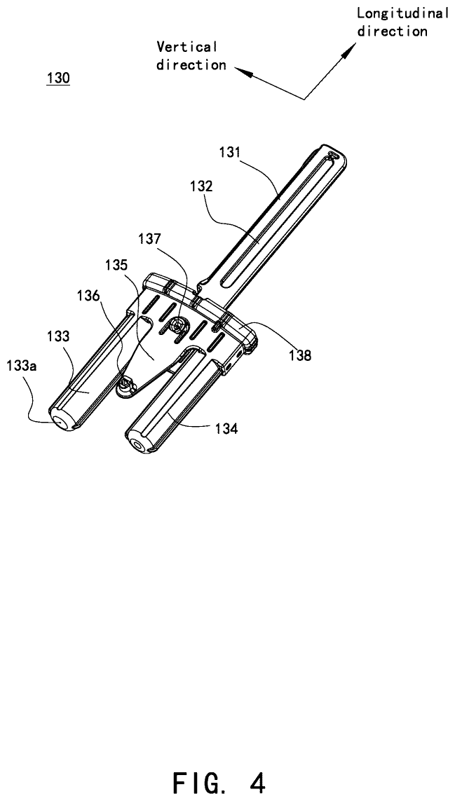

The baby bed 100 includes a bed body and supporting foot 160 arranged below the bed body. The lower end of the support foot 160 is connected to the telescopic mechanism according to the present application. The telescopic mechanism generally includes a first housing 110, a second housing 120, an engagement member 130 (the engagement member 130 is at least partially fixed in the second housing 120, as shown in FIGS. 4, 5B, 6B, 7 and 8), and an operating member 140.

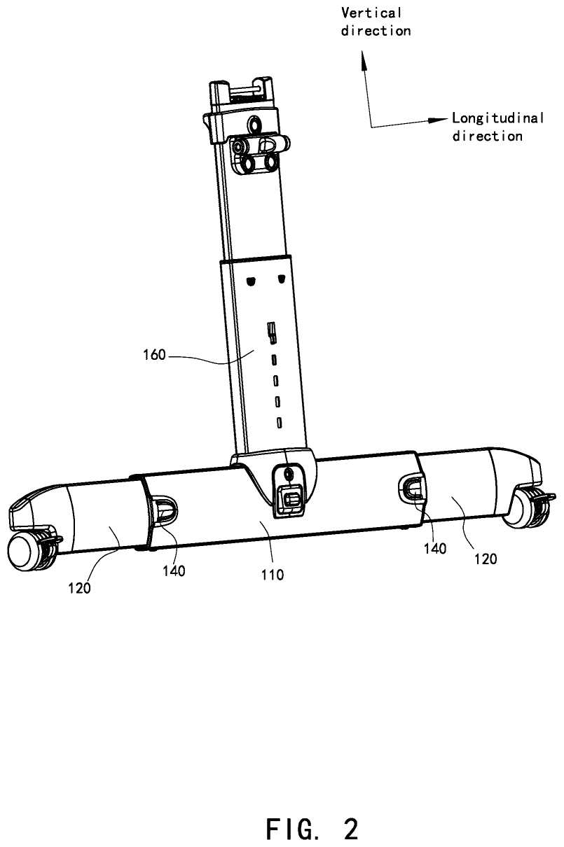

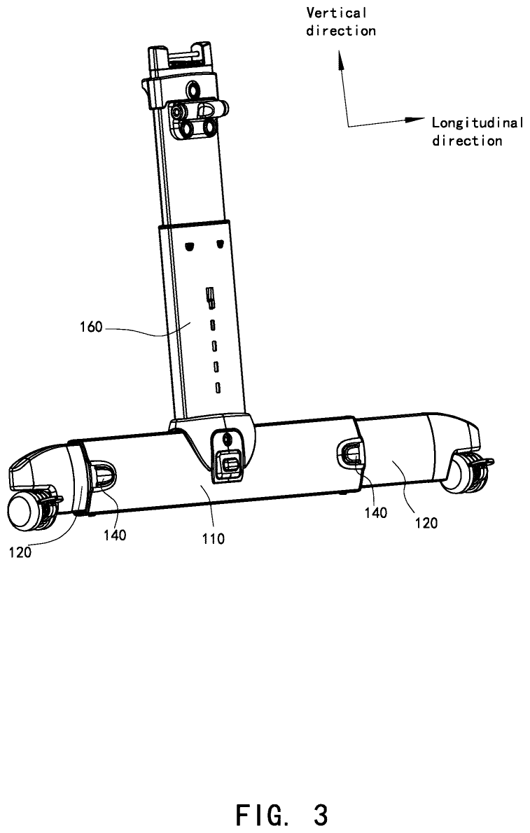

The first housing 110 is connected to the lower end of the support foot 160 and extends longitudinally. Two second housings 120 are respectively sleeved at the longitudinal ends of the first housing 110, and can independently move longitudinally relative to the first housing 110 between an extended position and a retracted position. The term “retracted position” herein not only refers to the position of the second housing 120 as shown in FIG. 3, but also refers to all positions during the process of retracting the second housing 120 back to the first housing 110 after leaving the extended position in FIG. 2. That is to say, the position reached by the second housing 120 retracting any distance is called the “retracted position”. FIG. 3 shows the position with the longest retraction distance in the retracted position.

The first housing 110 and the second housing 120 are both hollow, and the cross-section of the second housing 120 is slightly smaller than that of the first housing 110, and is sleeved on the inner side of the first housing 110. One end of each second housing 120 is inserted into the first housing 110, and the other end is connected to a roller or support foot (the figure shows the roller).

In this embodiment, the first housing 110 and the second housing 120 both extend generally longitudinally, and the second housing 120 moves longitudinally. Therefore, the first housing 110 and the second housing 120 have a simple and easy manufacturing structure. However, it should be understood that in other embodiments, the first housing 110 and the second housing 120 can be set to, for example, extend diagonally or curvedly, so that the second housing 120 correspondingly moves diagonally or curvedly.

In this embodiment, the first housing 110 and the second housing 120 are generally rectangular in cross-section perpendicular to the longitudinal direction, respectively. In other embodiments, the first housing 110 and the second housing 120 may have different cross-sectional shapes.

FIG. 2 shows a state where both second housings 120 are in the extended position, FIG. 3 shows a state where the second housing 120 on the left is in the retracted position, and the second housing 120 on the right is in the extended position. The engagement member 130 is used to guide the longitudinal movement of the second housing 120 and can keep the second housing 120 in the extended position, further details will be provided below. The operating member 140 is arranged on the outer surface of the first housing 110 and can be operated to act on the engagement member 130 to release the engagement member 130 from clamping the second housing 120.

Refer to FIG. 4, the specific structure of the engagement member 130 will be described.

The engagement member 130 includes a limiting part 131, a limiting groove 132, a first sleeve 133, a second sleeve 134, an engagement part 135, a first protrusion 136, a second protrusion 137, and an intermediate part 138. In view of the structure and operation of the engagement member 130, it may be considered as a holder or a clamping member.

The intermediate part 138 extends vertically and corresponds to the cross-sectional shape of the second housing 120, and is fixed at the end of the second housing 120 where the second housing 120 is inserted into the first housing 110. In one embodiment, the end of the second housing 120 inserted into the first housing 110 is an open end, and the intermediate part 138 encloses the open end.

From the intermediate part 138, the engagement part 135, the first sleeve 133, the second sleeve 134, and the limiting part 131 extend longitudinally, and the extension direction of the limiting part 131 is opposite to the extension direction of the engagement part 135, the first sleeve 133, and the second sleeve 134. Because the intermediate part 138 is located at the end of the second housing 120, the engagement part 135, the first sleeve 133, and the second sleeve 134 are inserted into the interior of the second housing 120, or in other words, extends toward the exterior of the first housing 110 (bottom left in FIG. 4).

Because the intermediate part 138 is arranged at the end of the second housing 120 and the second engagement part 135, the first sleeve 133, and the second sleeve 134 are inserted into the interior of the second housing 120, the engagement member 130 is stably fixed to the second housing 120. Moreover, the extension direction of the limiting part 131 is opposite to that of the engagement part 135, the first sleeve 133, and the second sleeve 134, so the limiting part 131 occupies no space in the second housing 120.

In this embodiment, the engagement member 130 is fixedly connected to the second housing 120. However, it should be understood that in other embodiments, the engagement member 130 may be configured to be movably connected to the second housing 120, for example, by an adjustable bolt, to allow for adjustment of the position of the engagement member 130 relative to the second housing 120.

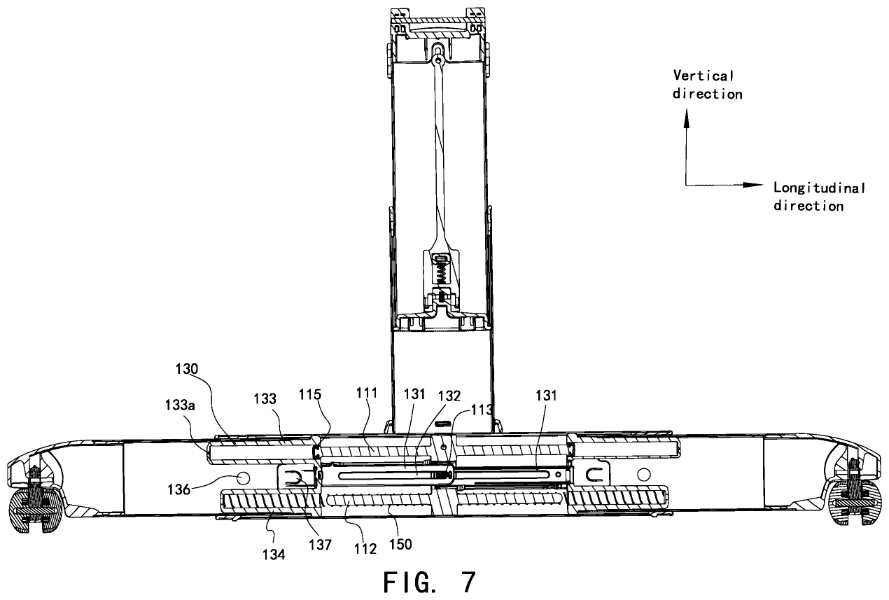

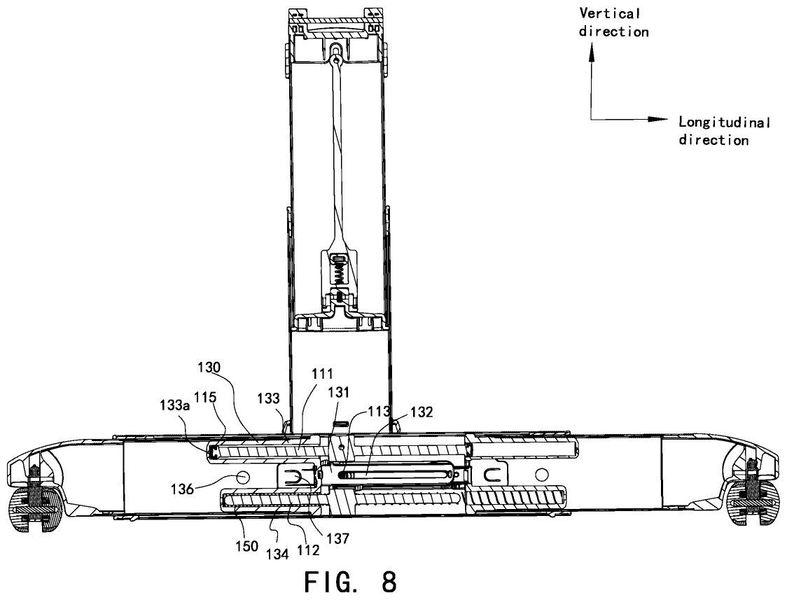

The engagement part 135 engages the second housing 120 to the first housing 110. When the second housing 120 is in the extended position, the engagement part 135 engages to the first housing 110. The first sleeve 133 and the second sleeve 134 cooperate with the first column 111 and the second column 112 inside the first housing 110 to guide the longitudinal movement of the second housing 120 (FIGS. 7 and 8). Moreover, the fit between the first sleeve 133 and the first column 111 is aimed at preventing the problem of the second housing 120 from popping out or retracting too quickly, and causing excessive impact sound; the purpose of the fit between the second sleeve 134 and the second column 112 is to position and guide the spring 150, further details will be provided below. The limiting part 131 is matched with the guiding pin 113 of the first housing 110 to limit the movement range of the second housing 120.

More specifically, the end of the engagement part 135 far from the intermediate part 138 is a free end and is equipped with a first protrusion 136. The first protrusion 136 extends laterally perpendicular to the longitudinal direction. When the second housing 120 is in the extended position, the first protrusion 136 fits into the engagement hole 114 of the second housing 120. The engagement part 135 is arranged as an elastic sheet that bounces laterally towards the outside of the first housing 110, and when the second housing 120 is in the extended position, the engagement part 135 can be pressed by the operating member 140 to disengage from the engagement with the first housing 110.

In this embodiment, the first protrusion 136 is arranged at the free end of the engagement part 135, which has a simple structure and ideal elasticity. The first protrusion 136 can accurately clamp in the engagement hole 114. In other embodiments, the engagement part 135 can also be set in other forms, such as a slider that can bounce laterally.

The engagement part 135 is located between the first sleeve 133 and the second sleeve 134 in the vertical direction, and located on the side of the first sleeve 133 and the second sleeve 134 in the lateral direction.

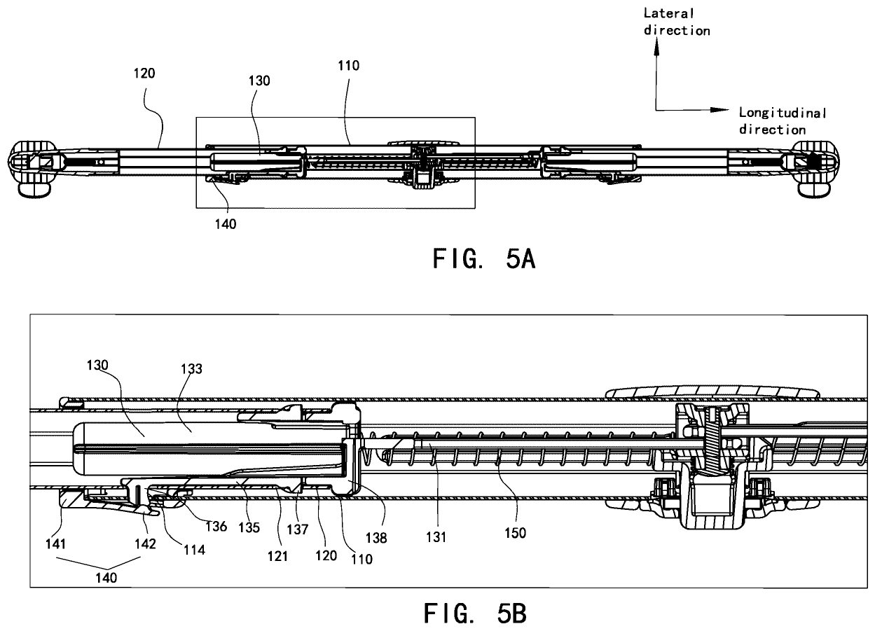

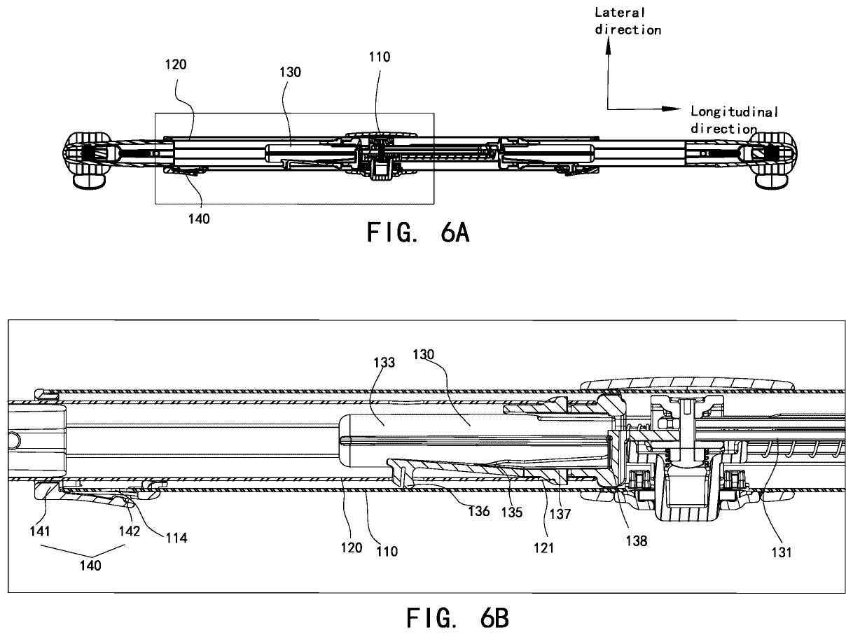

The engagement member 130 can also be equipped with a second protrusion 137, which is arranged as an elastic clamping convex structure connected to the second housing 120, that is, the second protrusion 137 is inserted into the opening 121 of the wall of the second housing 120 to connect the engagement member 130 to the second housing 120 (see FIGS. 5B and 6B).

The first sleeve 133 and the second sleeve 134 extend from the intermediate part 138 towards the outside of the first housing 110, respectively, and are arranged vertically. The first sleeve 133 and the second sleeve 134 are hollow cylindrical tubes, respectively, and the length of the first sleeve 133 is slightly larger than the length of the second sleeve 134. The number of sleeves is not limited to the two in this embodiment, but can be set to one or more, and multiple sleeves can have the same or different lengths.

Referring to FIGS. 5A to 6B, the operation of the telescopic structure according to the present application will be described.

As shown in FIGS. 5A and 5B, the second housing 120 is in the extended position. The first protrusion 136 on the engagement part 135 passes through the second housing 120 and engages into the engagement hole 114 of the first housing 110. Therefore, the engagement part 135 prevents the longitudinal movement of the second housing 120 relative to the first housing 110.

As further shown in FIG. 5B, the operating member 140 is located at the end of the first housing 110 and arranged to pressable laterally. The operating member 140 includes a fixed end 141 and an operating end 142. The fixed end 141 is fixed on the outer side of the first housing 110, and the operating end 142 corresponds to the position of the engagement hole 114. The operating member 140 is set as an elastic sheet, so that the operating end 142 remains attached to the first protrusion 136 in an unstressed state.

In this embodiment, the telescopic structure is designed so that when the second housing 120 is in an extended position, the first protrusion 136 is located near the end of the first housing 110, which can increase the stroke of the second housing 120. It should be understood that in other embodiments, the telescopic structure can be designed so that when the second housing 120 is in the extended position, the engagement part 135 has not yet moved near the end of the first housing 110 (for example, still staying within the first housing 110). In this case, the operating member 140 can be set at a position corresponding to the engagement part 135.

When the user needs to retract the second housing 120, he/she presses the operating end 142 of the operating member 140, thereby applying pressure to the first protrusion 136. The first protrusion 136 disengages from the engagement hole 114 under pressure and retracts back into the interior of the first housing 110, no longer preventing relative motion between the first housing 110 and the second housing 120. Therefore, the user can move the second housing 120 to the retracted position, for example, by abutting the exposed end of the second housing 120 outside the first housing 110 against the side of the adult bed to retract the second housing 120. At this point, the telescopic structure reaches the state shown in FIGS. 6A and 6B.

When the user needs to move the second housing 120 back to the extended position, only need to release the second housing 120, and the second housing 120 will return to the extended position under the action of the elastic member 150. At this point, the engagement part 135 pops out laterally under its own elastic action, causing the first protrusion 136 to be inserted into the engagement hole 114, thereby locking the relative movement between the first housing 110 and the second housing 120 and returning to the state shown in FIGS. 5A and 5B.

In this embodiment, the telescopic structure has a smaller lateral size and a larger longitudinal size. Therefore, when the engagement part 135 is set to move laterally, the contact surface used for pressing the engagement part 135 can extend longitudinally and have a larger contact area. It should be understood that in other embodiments, the telescopic structure may have different shapes, such as having different lateral size and longitudinal size, and the engagement part 135 may also be correspondingly set to move in other directions.

It should be understood that a locking device can also be provided between the first housing 110 and the second housing 120 to lock the second housing 120 in any retracted position. In this way, when the user needs to move the second housing 120 from the retracted position to the extended position, the locking device can be unlocked first. That is, the locking device prevents the second housing 120 from moving towards the extended position.

Referring to FIGS. 7 and 8, the operation of the telescopic structure will be further described, and the arrangement of the first sleeve 133, the second sleeve 134, the first column 111, the second column 112, the elastic member 150, and the limiting part 131 will be also described.

The first column 111 and the second column 112 are fixedly arranged in the first housing 110 and extend longitudinally, and can be inserted into the first sleeve 133 and the second sleeve 134 respectively to guide the longitudinal movement of the second housing 120. It should be understood that there can be only one column or more than two columns, and the number of columns corresponds to the number of sleeves.

As shown in FIG. 8, when the second housing 120 is in the retracted position, the first column 111 and the second column 112 are at least partially inserted into the first sleeve 133 and the second sleeve 134, respectively. As shown in FIG. 7, the length of the first column 111 is greater than the length of the second column 112. Therefore, when the second housing 120 is in an extended position, at least a part of the first column 111 is located in the first sleeve 133, and the second column 112 detaches from the second sleeve 134. More specifically, a plug 115 is provided at the end of the first column 111. The plug 115 is used to provide buffering effect. Specifically, the plug 115 seals the first sleeve 133 into a closed space, and an air hole 133a is provided at the closed end of the first sleeve 133. When the second housing 120 extends from the first housing 110, the plug 115 exits from the first sleeve 133, resulting in a negative pressure inside the first sleeve 133, which can slow down the extension speed of the second housing 120. Similarly, when the second housing 120 retracts into the first housing 110, the plug 115 can also slow down the retraction speed of the second housing 120. The elastic member 150 in the form of a coil spring is sleeved on the second column 112 and inserted into the second sleeve 134 to bias the second housing 120 towards the extended position.

The limiting part 131 extends longitudinally from the second housing 120 to the first housing 110, and is engaged in the first housing 110 to guide the longitudinal movement range of the second housing 120. More specifically, the limiting part 131 extends longitudinally from the intermediate part 138 towards the interior of the first housing 110, and a longitudinally extending limiting groove 132 is provided in the limiting part 131. The first housing 110 is fixedly equipped with a laterally extending guiding pin 113, which is inserted into the limiting groove 132 to guide the longitudinal movement of the second housing 120.

By comparing and referring to FIGS. 7 and 8, it can be seen that when the second housing 120 is in the retracted position, the limiting parts 131 of the two second housings 120 can overlap with each other, that is, they are laterally misaligned. In this way, the two second housings 120 do not interfere with each other and can overlap with each other to a certain extent, thereby increasing the range of movement of the second housing 120.

In summary, the present application provides a baby bed with a telescopic structure at the foot to change the length of the foot. Moreover, the telescopic structure can lock the foot in the extended position, and manual unlocking of the telescopic structure is necessary to allow the foot to change its length, thereby avoiding safety hazards caused by accidental retraction of the telescopic foot of the baby bed.

As the present application can be implemented in various forms without departing from the spirit and essence of the present application, it should be understood that the above embodiments are not limited to any of the aforementioned details, but should be interpreted in the broadest scope within the scope of the claims. Therefore, all changes falling within the scope of the claims or their equivalent should be covered by the claims.

1. A telescopic mechanism, wherein the telescopic mechanism comprises:
a first housing;
a second housing sleeved in the first housing and movable between an extended position and a retracted position relative to the first housing; and
an engagement member at least partially arranged in the second housing and engageable with the second housing in the extended position.

2. The telescopic mechanism according to claim 1, wherein the engagement member comprises:
a first protrusion engaged into an engagement hole of the first housing when the second housing is in the extended position.

3. The telescopic mechanism according to claim 2, wherein the telescopic mechanism further comprises:
an operating member operated to act on the engagement member, causing the first protrusion to detach from the engagement hole, wherein the operating member is releasable to allow the first protrusion to bounce back into the engagement hole.

4. The telescopic mechanism according to claim 3, wherein:
the engagement member includes an engagement part engageable to the first housing, wherein the first protrusion is arranged at a free end of the engagement part.

5. The telescopic mechanism according to claim 4, wherein:
the operating member is provided on the first housing and can be pressed; and
the engagement part is provided as an elastic sheet that bounces towards an outside of the first housing, and when the second housing is in the extended position, the engagement part is pressed by the operating member to disengage with the first housing.

6. The telescopic mechanism according to claim 1, wherein the engagement member comprises:
a limiting part extending from the second housing to the first housing and engaged in the first housing to limit a movement range of the second housing.

7. The telescopic mechanism according to claim 6, wherein:
the limiting part extends towards an interior of the first housing, and a limiting groove is provided in the limiting part; and
a guiding pin is provided in the first housing, and is inserted into the limiting groove to guide a movement of the second housing.

8. The telescopic mechanism according to claim 1, wherein:
the engagement member includes at least one sleeve, which extends from an end of the second housing inserted into the first housing towards an outside of the first housing; and
at least one column is provided in the first housing, and is insertable into the sleeve to guide a movement of the second housing.

9. The telescopic mechanism according to claim 8, wherein the engagement member further comprises:
an intermediate part arranged at an end of the second housing inserted into the first housing;
wherein an engagement part of the engagement member extends from the intermediate part towards the outside of the first housing.

10. The telescopic mechanism according to claim 9, wherein:
the at least one sleeve includes a first sleeve and a second sleeve, respectively extending from the intermediate part towards the outside of the first housing; and
the at least one column includes a first column and a second column, and when the second housing is in the retracted position, the first column and the second column are at least partially inserted into the first sleeve and the second sleeve, respectively.

11. The telescopic mechanism according to claim 10, wherein:
a length of the first column is greater than a length of the second column, and when the second housing is in the extended position, at least a part of the first column is located within the first sleeve.

12. The telescopic mechanism according to claim 11, wherein the telescopic mechanism further comprises:
an elastic element, wherein the elastic element is sleeved on the second column and inserted into the second sleeve to bias the second housing towards the extended position.

13. The telescopic mechanism according to any one of claim 1, wherein:
the engagement member is further provided with a second protrusion which is arranged to be inserted into an opening of a wall of the second housing to connect the engagement member to the second housing.

14. A baby bed, wherein the baby bed comprises:
a bed body;
a supporting foot arranged below the bed body; and
the telescopic mechanism according to claim 1, wherein the first housing is connected to a lower end of the supporting foot, and two second housings are respectively sleeved at longitudinal ends of the first housing.

15. The baby bed according to claim 14, wherein:
each second housing is connected to a roller at an end distal to the first housing, and the roller is configured to contact a ground surface when the second housing is in the extended position.

16. The telescopic mechanism according to claim 3, wherein:
when the second housing is in the extended position, the operating member is located corresponding to the engagement member.

17. The telescopic mechanism according to claim 7, wherein:
the limiting groove is longitudinally elongated to allow the second housing to move between the extended position and the retracted position, while the guiding pin restricts lateral displacement of the second housing.

18. The telescopic mechanism according to claim 12, wherein:
the first sleeve is provided with an air hole at a closed end thereof, and a plug is disposed at an end of the first column, such that extending movement of the second housing from the first housing is slowed down via a negative pressure generated inside the first sleeve.

19. The telescopic mechanism according to claim 13, wherein:
the second protrusion is configured as an elastic clamping structure.

20. The telescopic mechanism according to claim 1, further comprising:
a locking device configured to lock the second housing in any retracted position between the extended position and a fully retracted position.
